(19) United States
(12) Patent Application Publication
(10) Pub. No.: US 2008/0216012 A1
(43) Pub. Date: Sep. 4, 2008

(54) INSTRUCTION AND TRAINING TOOL

(75) Inventor: Christopher E. Leslie, Friendswood, TX (US)

Correspondence Address: GREENBERG TRAURIG, LLP, 2101 L Street, N.W., Suite 1000, Washington, DC, 20037, US

(73) Assignee: UNITED SPACE ALLIANCE, LLC, HOUSTON, TX (US)

(21) Appl. No.: 12/040,431

(22) Filed: Feb. 29, 2008

Related U.S. Application Data
(63) Continuation-in-part of application No. 11/467,075, filed on Aug. 24, 2006.
(60) Provisional application No. 60/910,536, filed on Apr. 6, 2007.
(60) Provisional application No. 60/711,414, filed on Aug. 26, 2005.

(51) Int. Cl. G06F 3/048

(52) U.S. Cl. 715/792

(57) ABSTRACT

An instruction and training tool which facilitates access to instructional materials and provides a simulated training environment for personnel. By integrating the instruction and training tool with resource planning and scheduling tools, personnel can easily review the procedures necessary for the day's tasks, and the schedule can be adjusted to afford personnel additional review time prior to performance of a particular task. By integrating the instruction and training tool with an information management system, personnel can gain access to additional information related to a particular task. Such an integrated tool can be a significant resource, especially for personnel operating in remote environments, where additional assistance and information may not otherwise be available.

This application claims priority from U.S. Provisional Patent Application Ser. No. 60/910,536, filed on Apr. 6, 2007, and is a Continuation-in-Part of and claims priority from U.S. patent application Ser. No. 11/467,075, filed Aug. 24, 2006, which claims priority from U.S. Provisional Patent Application Ser. No. 60/711,414, filed on Aug. 26, 2005, which are hereby incorporated by reference in their entirety.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD

The instant disclosure relates to the field of personnel training and instruction, and more specifically provides a tool through which personnel can easily access instructional materials and train to use a variety of systems.

### BACKGROUND

Ensuring personnel receive proper instruction and training is critical to any organization's success. Personnel operating aboard remote vessels, such as, but not limited to, ships, submarines, oil platforms, and the like at sea, and aircraft and spacecraft in the air, must be especially well trained. Unlike traditional, terrestrial jobs, where resources are readily available to help solve any problems that may be encountered, personnel onboard such vessels must ensure that proper procedures are followed to reduce the likelihood that errors or accidents will occur, and must be more self-sufficient in the event of an error or accident.

Conventional instruction and training for personnel who work onboard such vessels typically consists of the personnel performing tasks in a physical, simulated environment. By way of example, without limitation, personnel learning to pilot a ship will frequently do so in a simulated bridge, complete with all of the physical controls found on that particular ship or class of ships.

While such simulated environments are advantageous in that they can provide an environment that is about as close to the real bridge of a ship as possible, the construction and maintenance of such simulated environments is very expensive. In addition, the size, weight, and other aspects of such simulators requires that personnel wishing to be trained in those environments to travel to the simulators.

### SUMMARY

It would be advantageous for personnel to continue training in the performance tasks even when the simulator is unavailable. Accordingly, the instant disclosure is directed to an instruction and training tool that leverages computer-based simulations of various environments, and which provides a convenient, common interface to such information. By providing a more convenient environment through which training and instruction can be facilitated, the instant instruction and training tool improves personnel access to training and instruction regardless of the personnel location.

Some embodiments comprise, computer readable media having computer-readable instructions for providing an instruction and training tool tangibly stored thereon, the computer-readable instructions, when executed by a computer comprising: providing a user interface, the user interface comprising: a systems pane, the systems pane displaying a listing of tasks for which instructions are available; a tools pane, the tools pane displaying a listing of tools and materials necessary to complete a task; a procedure pane, the procedure pane displaying instructions on how to perform a task, the instructions comprising a plurality of steps; and, a simulation pane, the simulation pane displaying an object; and, receiving, via the systems pane, a user task selection; and, updating the tools pane, the procedure pane, and the simulation pane, such that the tools pane displays the tools and materials, the procedure pane displays the instructions, and the simulation pane displays the object, corresponding to the user task selection.

In some embodiments, the instructions for providing an instruction and training tool may further comprise receiving user input corresponding to performing a step; and, updating the simulation pane to reflect the user performing a step.

In some embodiments, the listing of tasks may be displayed hierarchically.

In some embodiments, the simulation pane may display the object as a three-dimensional representation.

Additional features and advantages of the invention will be set forth in the description which follows, and in part will be apparent from this disclosure, or may be learned by practice of the invention. The objectives and other advantages of the invention will be realized and attained by the structure particularly pointed out in this written description, including any claims contained herein and the appended drawings.

The instruction and training tool can be integrated with other tools, including, without limitation, the scheduling tool described in U.S. patent application Ser. No. 11/467,075, filed Aug. 25, 2006, which is incorporated herein by reference in its entirety. By integrating the instruction and training tool with a scheduling tool, tasks can be scheduled such that personnel are afforded time to review the instruction and/or walk through a simulation of the task before performing the actual task, or concurrently with the performance of the task, such that the personnel are better prepared to perform the task.

The instruction and training tool can also be integrated with the information management system described in U.S. patent application Ser. No. 11/466,508, filed Aug. 23, 2006, which is incorporated herein by reference in its entirety. By integrating the instruction and training tool with an information management tool, personnel can readily access additional information about a part, tool, supply, or the like related to the task at hand. By way of example, without limitation, a task may involve removing an air filter, which involves merely rotating the filter from its housing. This process can be easily illustrated and exemplified as part of the instruction and training tool. However, if the housing comes free during the actual replacement process, the person performing the task can take advantage of the integration with the information management tool to quickly access instructions for replacing or repairing the housing.

The instruction and training tool can also be integrated with a tool such as that described in the Provisional U.S. Patent Application Ser. No. 60/910,538, a corresponding nonprovisional application for which is filed on even-date herewith entitled “Stowage and Center of Gravity Assessment Tool”. Such integration can allow personnel to readily identify the storage location of any parts, tools, supplies, or the like that may be required as a result of an anomaly that occurs while performing a task.

It is to be understood that both the foregoing general description and the following detailed description are exemplary and explanatory and are intended to provide further explanation of the disclosed instruction and training tool.

### BRIEF DESCRIPTION OF THE DRAWINGS

The accompanying drawings, which are included to provide a further understanding of the disclosed instruction and training tool and are incorporated in and constitute a part of this specification, illustrate various embodiments and, together with the description, serve to explain the principles of at least one embodiment of the disclosed instruction and training tool.

In the drawings:

FIG. 1 is a screen capture of an exemplary user interface through which a user can access the instruction and training tool.

FIG. 2 is a screen capture of an exemplary user interface through which a user can access instructions for performing a particular procedure.

FIG. 3 is a screen capture of an exemplary user interface through which a user can practice performing the procedure outlined in FIG. 2.

FIG. 4 is a screen capture of an exemplary user interface through which a user can access an integrated information management application.

FIG. 5 is an exemplary network architecture supporting the instant instruction and training tool.

### DETAILED DESCRIPTION

Reference will now be made in detail to embodiments of the disclosed instruction and training tool, examples of which are illustrated in the accompanying drawings.

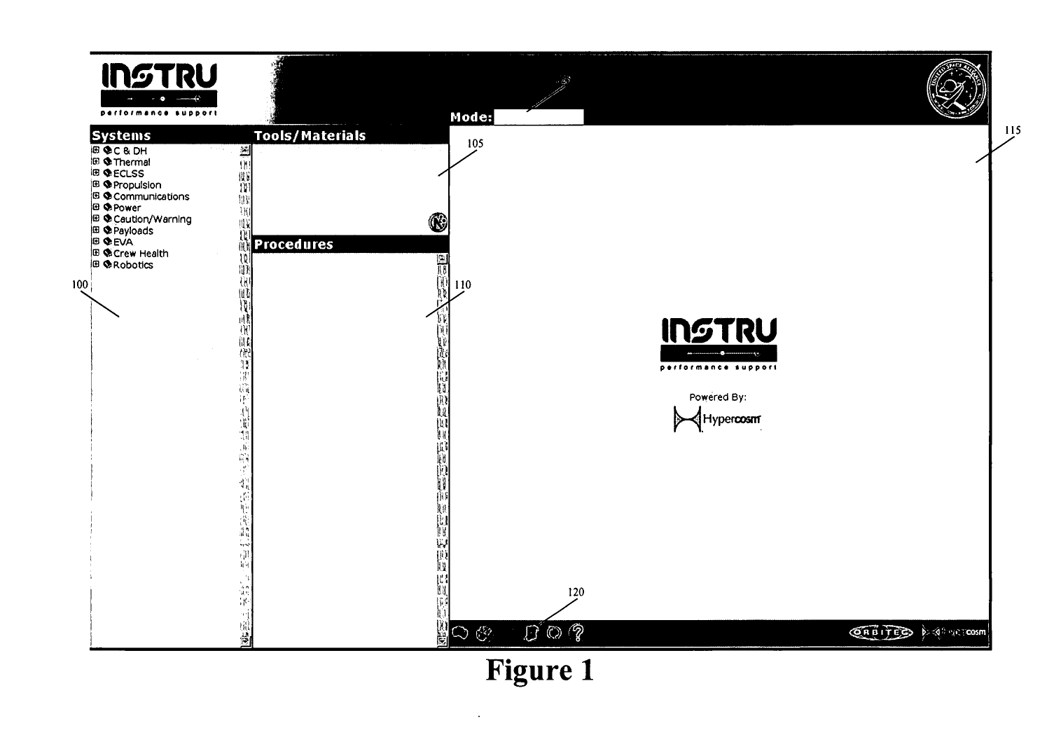

FIG. 1 is a screen capture of an exemplary user interface through which a user can access the instruction and training tool. In this exemplary embodiment, the user interface comprises a plurality of navigation panes, including systems pane 100, tools/materials pane 105, and procedures pane 110. The exemplary user interface also includes simulation pane 115 and the related controls 120. Finally, the exemplary user interface also includes mode indicator 125.

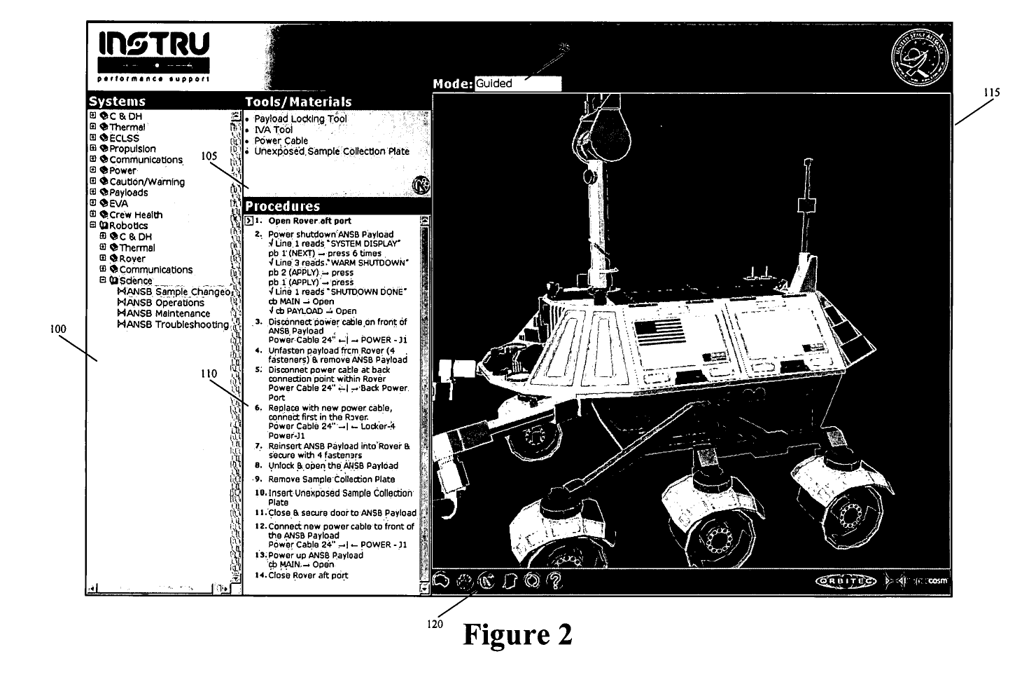

FIG. 2 is a screen capture of the exemplary user interface of FIG. 1, in which personnel are reviewing procedures for changing out samples in a rover. As illustrated in FIG. 2, systems pane 100 provides an hierarchically structured listing of the tasks for which instructions are available from the instruction and training tool. In the illustrated example, the personnel have navigated to the desired task (ANSB Sample Changeout) and selected it. Such selection may occur by the personnel clicking on, touching, or otherwise interacting with the desired task.

When the personnel have selected the desired task in systems pane 100, the instruction and training tool alters tools/materials pane 105 to reflect a listing of the tools and materials needed when performing the task. Similarly, procedures pane 110 is altered to provide a detailed set of instructions for performing the task. Still further, simulation pane 115 is altered to provide a representation of the vehicle, component, part, or other item to which the instructions pertain. Although illustrated in FIG. 2 as a three dimensional representation of the item on which the sample changeout is to occur, one or more two dimensional representations may be substituted therefor without departing from the spirit or the scope of the disclosed instruction and training tool.

When in guided mode, as indicated by mode indicator 125, the instruction and training tool can walk the user through the procedures associated with performing the task. As the instruction and training tool progresses through the procedures, simulation pane 115 can be updated to reflect the anticipated appearance of the item on which the task is being performed.

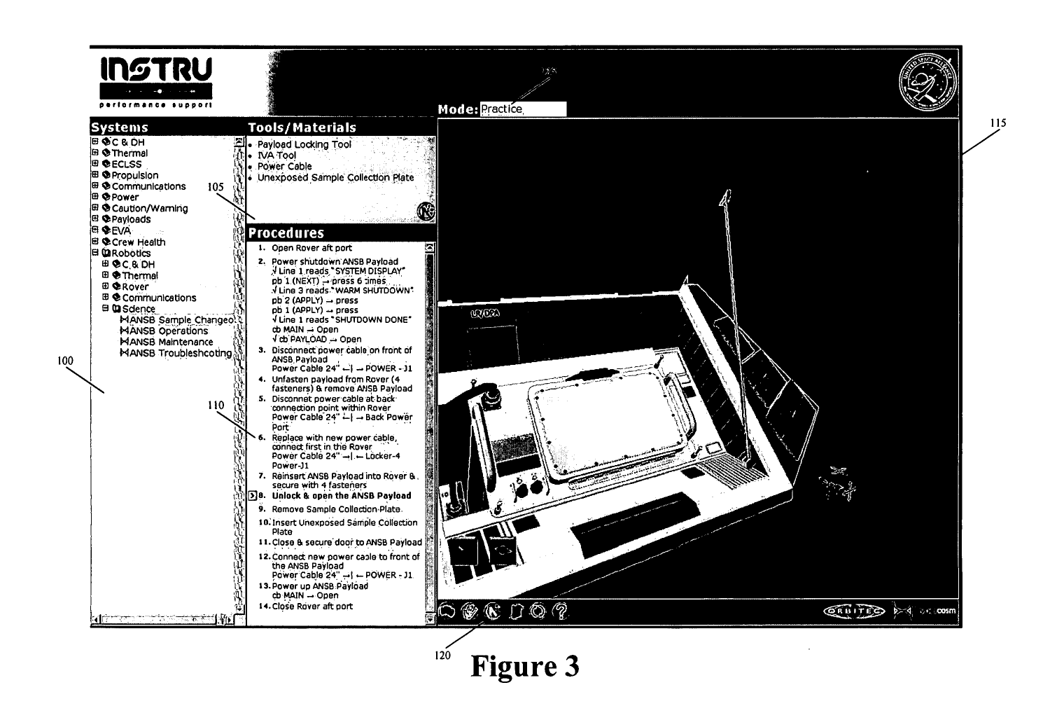

FIG. 3 is a screen capture of an exemplary user interface through which a user can practice performing the procedure outlined in FIG. 2. This is referred to herein as “practice” mode, and the personnel can easily distinguish between guided and practice modes based on mode indicator 125. In the example illustrated in FIG. 3, the user interacts with the item illustrated in simulation pane 115 to perform the steps outlined in procedure panel 110. By way of example, without limitation, if the user is told to “open rover aft port”, the user can use controls 120 to rotate the rover to show the rover aft port, zoom in to a desired level of detail, click on or otherwise interact with the handle for the aft port, and cause the aft port to open. In some embodiments, the practice mode may cause anomalies to occur, thereby further training personnel for real-world problems. By way of example, without limitation, a simulated screw may act as though it was “stripped”, and the personnel would have to handle that situation even though it departs from the procedures outlined in procedure pane 110. The instruction and training tool can record personnel responses to such anomalies, and both help assess personnel proficiency and identify steps in the procedure which may need to be redesigned.

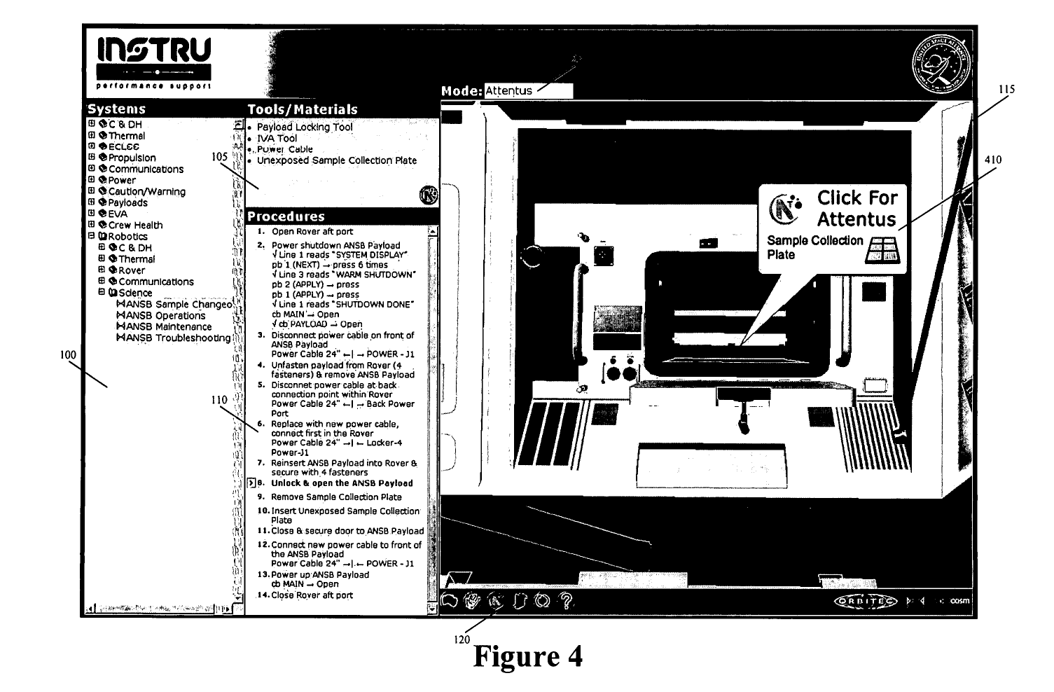

FIG. 4 is a screen capture of an exemplary user interface through which a user can access an integrated information management application, which may be helpful during anomaly training or when an anomaly is experienced while the task is being performed. In FIG. 4, the user is able to access additional information about a part by clicking on dialog box 410. The user may also access such information by clicking a help button in controls 120.

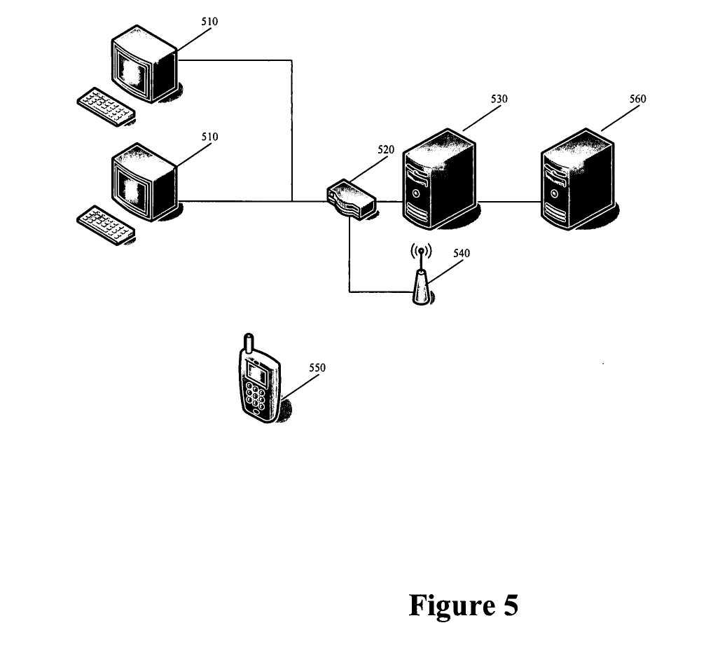

FIG. 5 is an exemplary network architecture supporting the instant instruction and training tool. In FIG. 5, server 530 houses the data and software necessary to create the instruction and training tool. In an embodiment, server 530 may comprise at least one database in which information is stored. Examples of such a database include, without limitation, the SQL Server database software distributed by the Microsoft Corporation of Redmond, Wash.; MySQL, distributed by MySQL AB of Sweden; and Access, distributed by the Microsoft Corporation. Server 530 may also comprise at least one world wide web server for transmitting the information to a computing device operated by personnel. Examples of such world wide web servers include, without limitation, the Apache web server distributed by the Apache Software Foundation of Forest Hill, Md.; and Internet Information Server, distributed by the Microsoft Corporation.

Workstations 510 may comprise a conventional web browser, such as, without limitation, the Internet Explorer web browser distributed by the Microsoft Corporation, and the Mozilla Firefox web browser, distributed by the Mozilla Corporation of Mountain View, Calif. Such a web browser can allow personnel to view the information provided by server 530 and to otherwise interact with server 530.

Although illustrated as employing a wired interface between workstations 510 and server 530 (by way of router 520), some embodiments also support the use of wireless communications with server 530. By way of example, without limitation, personnel may be equipped with wireless device 550, and may access server 530 by way of wireless access point 540. A wireless connection can allow, for example, server 530 to be remote from workstations 510. By way of example, without limitation, workstations 510 may be on a spacecraft, and server 530 may be on the ground in mission control.

In addition to facilitating access to the information stored in server 530, as described above server 530 may also facilitate access to information stored on information management server 560.

While detailed and specific embodiments of the instruction and training tool have been described herein, it will be apparent to those skilled in the art that various changes and modifications can be made therein without departing from the spirit and scope of the instruction and training tool. Thus, it is intended that the present disclosure cover these modifications and variations provided they come within the scope of any appended claims and/or their equivalents.

1. Computer readable media having computer-readable instructions for providing an instruction and training tool tangibly stored thereon, the computer-readable instructions, when executed by a computer comprising:
providing a user interface, the user interface comprising:
i) a systems pane, the systems pane displaying a listing of tasks for which instructions are available;
ii) a tools pane, the tools pane displaying a listing of tools and materials necessary to complete a task;
iii) a procedure pane, the procedure pane displaying instructions on how to perform a task, the instructions comprising a plurality of steps; and,
iv) a simulation pane, the simulation pane displaying an object; and,
receiving, via the systems pane, a user task selection; and,
updating the tools pane, the procedure pane, and the simulation pane, such that the tools pane displays tools and materials, the procedure pane displays instructions, and the simulation pane displays an object, corresponding to the user task selection.

2. The computer readable media of claim 1, further comprising instructions for:
receiving user input corresponding to performing a step; and,
updating the simulation pane in response to the user performing a step.

3. The computer readable media of claim 1, the listing of tasks being displayed hierarchically.

4. The computer readable media of claim 1, the simulation pane displaying the object as a three-dimensional representation.

5. The computer readable media of claim 2, the user input comprising one or more actions performed on the object displayed in the object pane.

6. The computer readable media of claim 5, the user input further comprising the use of one or more tools on the object displayed in the simulation pane.

7. The computer readable media of claim 5, the user input further comprising the use of one or more materials on the object displayed in the simulation pane.

8. The computer readable media of claim 5, further comprising instructions for introducing an anomaly into the user task selection, the anomaly comprising one or more steps that are added to the task, thereby increasing the complexity of the task.

9. The computer readable media of claim 8, further comprising instructions for:
receiving user input corresponding to performing the one or more steps of the anomaly; and,
updating the simulation pane to reflect the user performing the one or more steps of the anomaly.

10. The computer readable media of claim 9, the user input comprising one or more actions performed on the object displayed in the object pane.

11. The computer readable media of claim 10, the user input further comprising the use of one or more tools on the object displayed in the simulation pane.

12. The computer readable media of claim 10, the user input further comprising the use of one or more materials on the object displayed in the simulation pane.

13. The computer readable media of claim 9, further comprising instructions for:
determining a proficiency rating based upon the user input received in response to the anomaly.

14. The computer readable media of claim 9, further comprising instructions for:
identifying one or more steps within the anomaly that need to be redesigned.

15. The computer readable media of claim 1, the user interface further comprising an integrated information management application, the integrated information management application capable of displaying additional information about an element within at least one of: the systems pane, the tools pane, the procedure pane, and the simulation pane.
